(19) United States
(12) Patent Application Publication
(10) Pub. No.: US 2016/0003975 A1
(43) Pub. Date: Jan. 7, 2016

(54) A RADIOSONDE AND A METHOD FOR ATMOSPHERIC MEASUREMENTS PERFORMED AT AN ELEVATED TEMPERATURE

(71) Applicant: VAISALA OYJ, Helsinki (FI)

(72) Inventors: Tomi SALO, Espoo (FI); Eero HILTUNEN, Klaukkala (FI); Jukka LEPPANEN, Luhtajoki (FI); Markus TURUNEN, Helsinki (FI)

(73) Assignee: VAISALA OYJ, Helsinki (FI)

(21) Appl. No.: 14/770,037

(22) PCT Filed: Feb. 17, 2014
(86) PCT No.: PCT/FI2014/050117

§ 371 Date: Aug. 24, 2015

(30) Foreign Application Priority Data
Feb. 22, 2013 (FI) 20135162

(51) Int. Cl. G01W 1/08

(52) U.S. Cl. CPC G01W 1/08

(57) ABSTRACT

The invention relates to a method and a radiosonde. According to the method at least temperature and relative humidity of the atmosphere are measured by a radiosonde. In accordance with the invention the humidity measurement is performed continuously in an elevated temperature in order to make the measurement faster and both the elevated temperature and ambient air temperature are measured simultaneously and based on these values relative humidity is determined and the humidity sensing elements are positioned on a planar substrate.

### BACKGROUND OF THE INVENTION

The present invention relates to a method in a radiosonde according to the preamble of claim 1.

The invention also relates to a radiosonde.

A radiosonde (also called a sounding device) is a weather observation device, which is attached to a gas balloon, measuring atmospheric parameters and sending the measurement information typically to a ground based station. Measured or calculated parameters typically include atmospheric temperature, pressure, and humidity, as well wind speed and direction, at various altitudes.

The balloon filled with helium or hydrogen lifts the radiosonde up through the atmosphere. As the balloon ascends through the atmosphere, the pressure decreases, causing the balloon to expand. Eventually, the balloon will burst, terminating the ascent.

The prior art radiosonde communicates via radio with a computer that stores all the variables in real-time.

Modern radiosondes can use a variety of mechanisms for determining wind speed and direction, such as GPS or other satellite based navigation systems

Sometimes radiosondes are deployed by being dropped from an aircraft instead of being carried aloft by a balloon.

One of the major parameters to be measured by radiosondes is humidity either as relative humidity or as a dew point parameter. One of the objects of this humidity measurement is detection of clouds and their altitude. The problem with the prior art is the long response time of the humidity measurement of the measurement. This is emphasized by the nature of the measurement process, because the temperature range during the measurement process is very large (+40 . . . −80C°). The slowness of the humidity measurement causes two kinds of problems. Firstly, the altitude of the detected cloud is not precise and secondly the thinnest cloud structures may even be undetected because minimum and maximum levels of humidity or of the cloud are not detected by the measurement. These inaccuracies may cause even hazards for air traffic, because sounding by radiosondes is an essential meteorological information source used by air traffic control.

### BRIEF SUMMARY OF THE INVENTION

The invention is intended to eliminate at least some of the shortcomings defects of the state of the art disclosed above and for this purpose create an entirely new type of method for radiosondes and a radiosonde.

The invention is based on heating continuously the humidity sensing element during the measurement phase of the radiosonde and positioning the humidity sensing elements on a planar substrate.

In one advantageous solution of the invention the heating is performed by a humidity sensing element in which temperature sensor, humidity sensor and heating element are positioned symmetrically in relation to the direction of the main air flow during the measurement of a ascending ordinary radiosonde or a descending dropsonde.

In one advantageous solution of the invention the heating is controlled by a constant temperature difference between the sensor and the environment controlled by an accurate temperature measurement of both the ambient air and the humidity sensor.

In one advantageous solution of the invention the heating is controlled by a constant heating power of the heating element.

The main air flow during the measurement is typically vertically descending flow because of the ascending movement of the radiosonde. The same is true with opposite direction of the air flow with a drop radiosonde for obvious reasons.

In a typical solution of the invention the humidity sensor is a capacitive sensing element.

More specifically, the method according to the invention is characterized by what is stated in the characterizing portion of claim 1.

The apparatus according to the invention is, in turn, characterized by what is stated in the characterizing portion of claim 5.

Considerable advantages are gained with the aid of the invention.

By heating the measurement can be made faster, which makes the detection of the clouds more accurate. Also sensitivity will be increased.

Some prior art solutions present pulsed heating of the temperature sensor either for calibration or anti-freezing purposes, but the pulsed methods do not give the advantages of the continuous warming but instead cause delays and pauses in the measurement. In these measurements also the control principle is based on humidity levels. At low humidity levels by this prior art solution no advantages are gained.

With the advantageous symmetrical layout of the humidity sensing element the temperature measurement of the humidity sensor can be made more accurate.

### BRIEF DESCRIPTION OF THE SEVERAL VIEWS OF THE DRAWINGS In the following, the invention is examined with the aid of examples and with reference to the accompanying drawings.

FIG. 1 shows schematically a radiosonde launched from a launching device.

FIG. 2 shows a radiosonde in accordance with the invention.

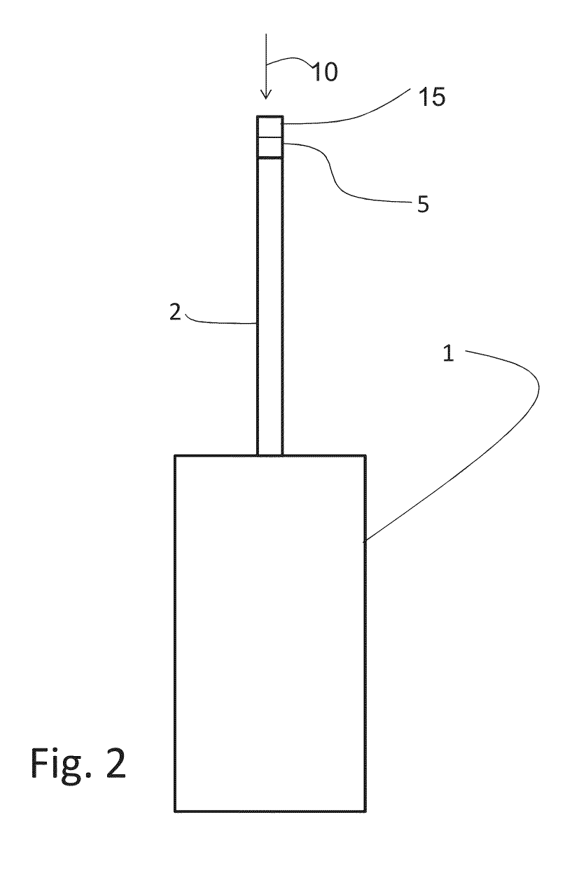

FIGS. 3a-3d show alternative humidity sensor elements in accordance with the invention.

FIGS. 4a-4c show alternative humidity sensor elements in accordance with the invention.

FIGS. 5a-5b show alternative humidity sensor elements in accordance with the invention.

FIGS. 6a-6c show alternative humidity sensor elements in accordance with the invention.

FIGS. 7a-7c show alternative humidity sensor elements in accordance with the invention.

### LIST OF TERMS USED

1 radiosonde, sonde
2 measurement beam
3 balloon
4 balloon cord
5 humidity sensing element
10 the main flow direction
11 capaciteve humidity sensor
12 temperature sensor, second temperature sensor
13 heating element (typically resistive)
14 contact pad
15 other sensors like a first temperature sensor
16 center line of the humidity sensing element

### DETAILED DESCRIPTION OF THE INVENTION

As a summary a typical implementatinon of the invention is a humidity sensor 11, typically capacitive, with an integrated temperature measurement element 12 and with a heating element 13. The temperature of the humidity sensor 11 is kept a few centigrades higher than the ambient temperature, which is measured independently by another temperature sensor 15 of the radiosonde 1. Either set temperature difference or constant power is used for controlling the heating. The relative humidity is calculated using the temperature information of the ambient air in accordance with the following known formula.

$${RH}_{a} = {RH}_{s} [ \frac{{ew}_{s} at {T}_{s}}{{ew}_{a} at {T}_{a}} ]$$

where
RHₐ=true relative humidity
RHₛ=relative humidity of a mixture contiguous with
a humidity sensitive film on a substrate 11
eWₛ=the saturation vapor pressure at the substrate 11
temperature measured by temperature sensor 12
eWa=saturation vapor pressure of the surrounding
mixture at temperature Tₐ
Tₛ=subsrtrate 11 temperature measured by temperature sensor 12
Tₐ=ambient temperature measured by independent sensor 15

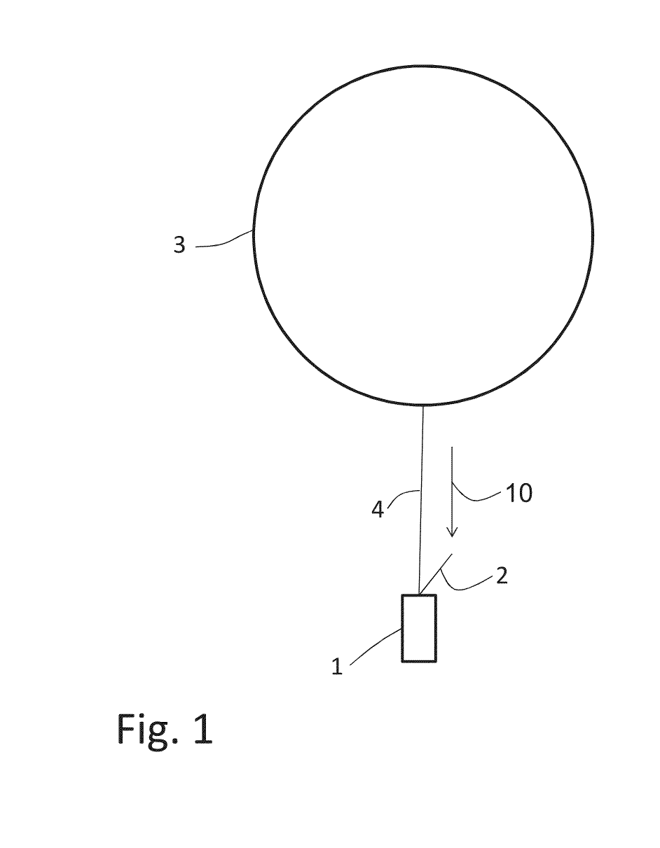

In accordance with FIG. 1, the radiosonde 1 is attached to the balloon 3 by a cord 4. The combination of the balloon 3 and the radiosonde 1 flies horizontally transported by an air current. Because in the upper atmosphere (the stratosphere) wind eddies (i.e. local changes in the speed or direction of the wind) are small, the balloon 3 and the radiosonde 1 rapidly accelerate horizontally to the speed of the wind current, whereby the thrust caused by the wind ceases. In an area of steady wind, the balloon 3 and radiosonde 1 combination follows the movements of the ambient air very precisely in the horizontal plane. In other words the common centre of gravity of the balloon 3 and radiosonde 1 moves with the air horizontally in calm air. In the vertical direction, the buoyancy of the balloon produces an upward rate of ascent relative to the air. The radiosonde 1 comprises a measurement beam 2 with necessary measuring instruments 5 and 15 connected to measurement electronics, telecommunication electronics and a power source like a battery inside the radiosonde 1. Nowadays, also GPS positioning electronics are typically included in the radiosonde 1.

The measurement beam 2 including measurement elements 5 and 15 is pointing upwards to the direction of the air flow 10 caused by the ascending balloon 3. Naturally, the direction 10 of the air flow is not steady but varies all the time, but in average the arrow represents well enough the direction of a typical flow. As seen in FIG. 1, the measurement beam is not pointing directly upwards but can also be tilted around 0-90 degrees typically about 45 degrees to horizontal direction in order to set the measurement elements 5 and 15 into more advantageous position for the measurement of various parameters.

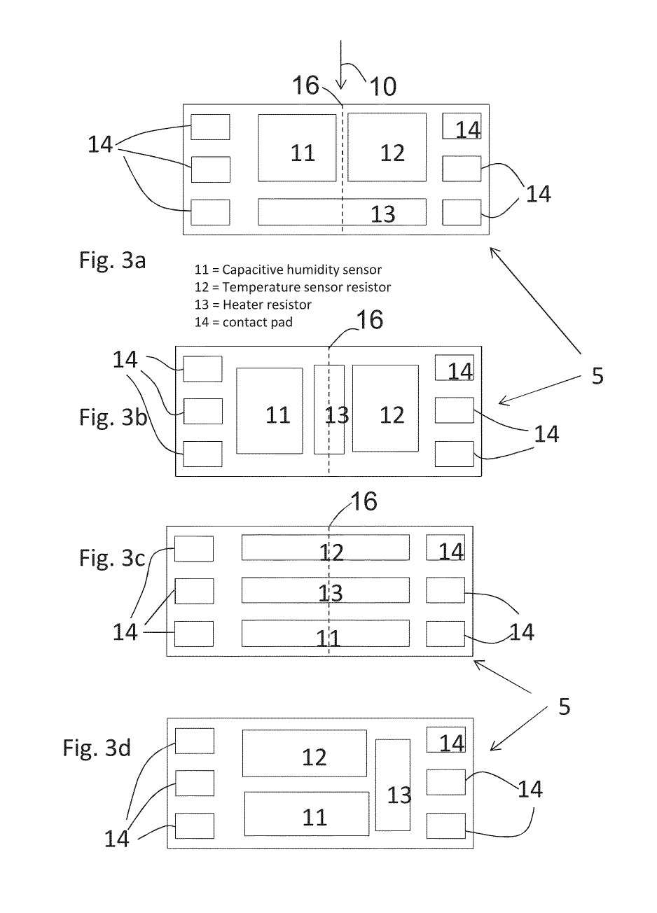

In accordance with FIG. 3a the main air flow comes in accordance with the arrow 10 from top to bottom. The orientation of all FIGS. 3a-3d is the same with the main direction 10 of the flow. The humidity sensing element 5 comprises three main active elements: a humidity sensor 11, a temperature sensor 12 and a heating element 13 and contact pads 14 for connecting the elements 11, 12, and 13 to the sensor electronics positioned inside the radiosonde 1.

In FIG. 3a the humidity sensor 11 and the temperature sensor 12 are positioned symmetrically around the vertical center line 16 of the humidity sensing element 5. The heating element 13 is also positioned symmetrically in relation to the vertical center line 16 of the element 5, namely horizontally at the center of the bottom part of the element 5. By this positioning the influence of the heating is the same for both humidity sensing element 11 and temperature sensing element 12.

In FIG. 3b the symmetry is implemented by positioning the heating element 13 vertically on the center line 16 along the main direction of the air flow 10 between the humidity sensor 11 and temperature sensor 12.

In FIG. 3c the symmetry is implemented by positioning the heating element 13 horizontally between the humidity sensor 11 and temperature sensor 12.

FIG. 3d shows a situation, where elements are not symmetrical but the heating element 13 is positioned on one side of the humidity sensing element 5. In all FIGS. 3a-3d the contact pads 14 are positioned on the sides of the humidity sensing element 5.

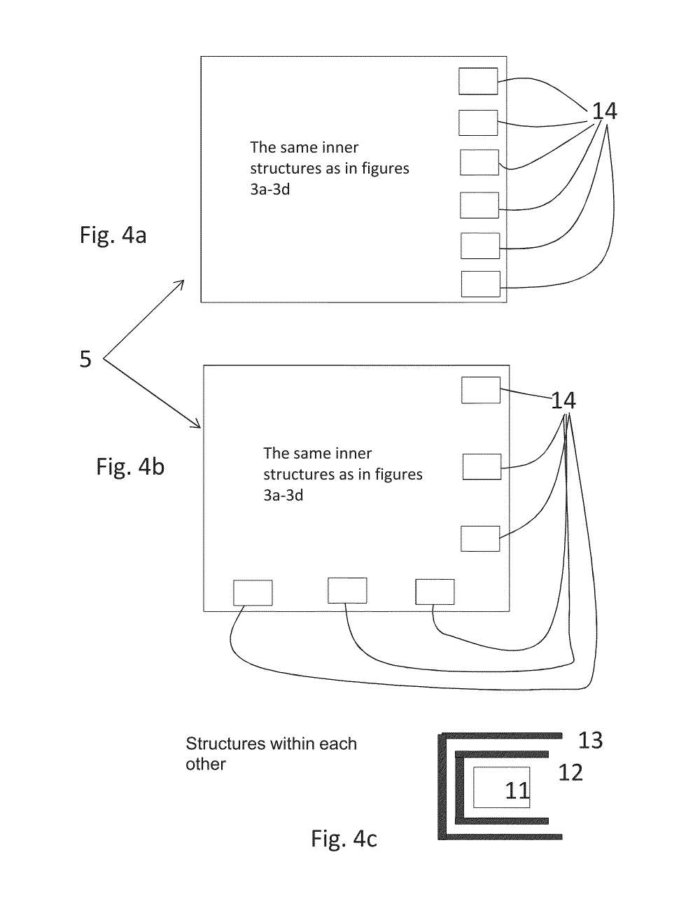

In accordance with FIG. 4a the contact pads 14 may be positioned on one side of the humidity sensing element 5.

In accordance with FIG. 4b the contact pads may be positioned on one side and on the bottom of the humidity sensing element 5.

In accordance with the FIG. 4c the humidity sensor element 11 may be surrounded by the temperature sensor, which in turn is surrounded by the heating resistor 13.

In the embodiments of FIGS. 3a-4c the elements 11-13 are positioned on the same side of the humidity sensing element. The invention may be implemented both as a multi-layer and two sided structure such that elements 11-13 are overlapped of above each other.

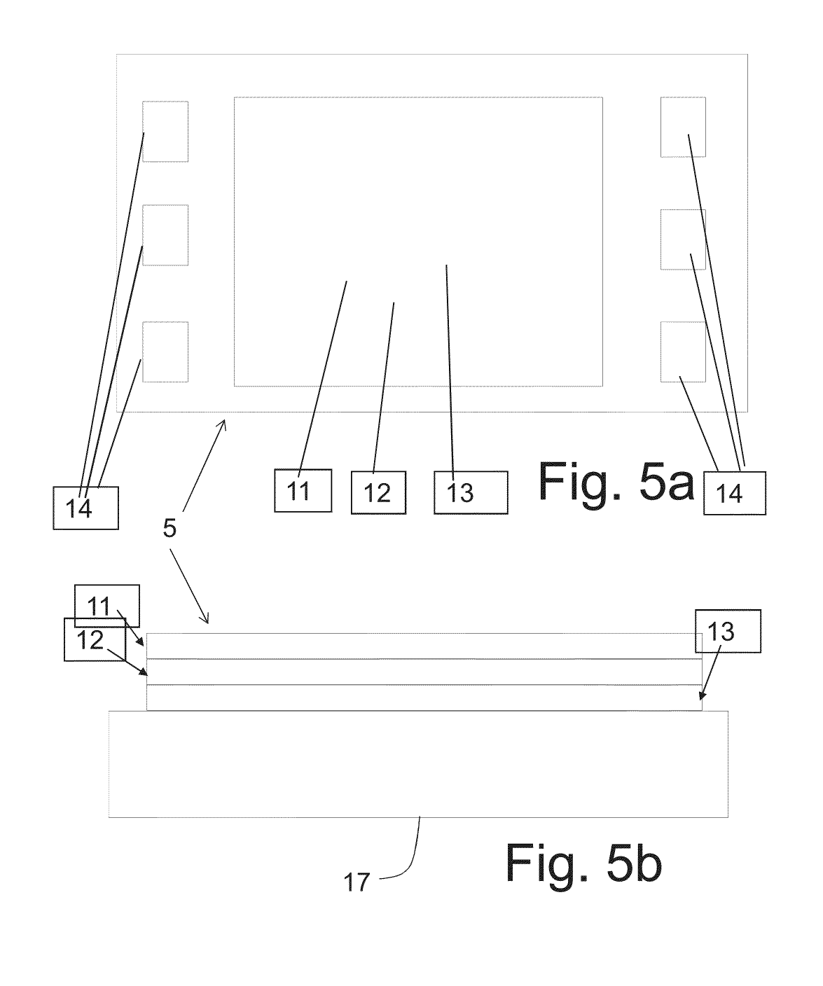

In the embodiment of FIGS. 5a-5b (5a top view and 5b side view) is shown a one sided multilayer solution for humidity sensing element 5. The elements 11-13 are equally sized layers above each other such that the humidity sensor 11 is on the top and the heating element 13 at the bottom and temperature sensing element 12 positioned between these two elements 11 and 13.

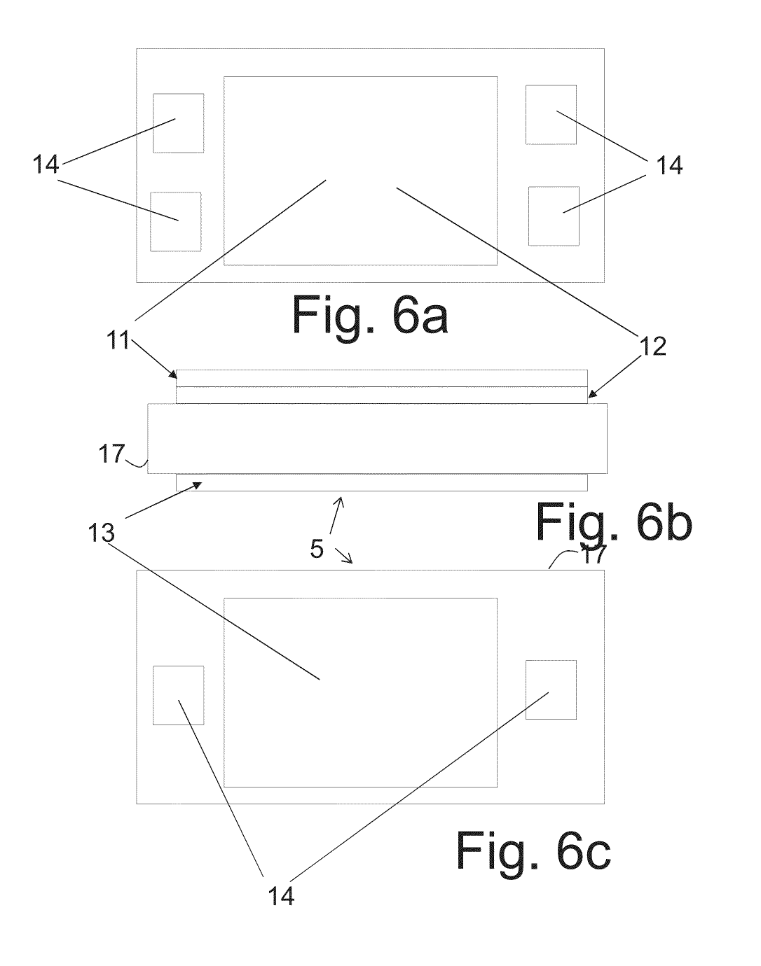

In the embodiment of FIGS. 6a-6c (6a top view, 6b side view and 6c bottom view) is shown a two sided humidity sensing element 5, where the heating element 13 is positioned at the back of the substrate 17 and on the other side of the substrate 17 the humidity sensor 11 and temperature sensor 12 are located above each other, naturally the humidity sensor 11 on the top or the structure.

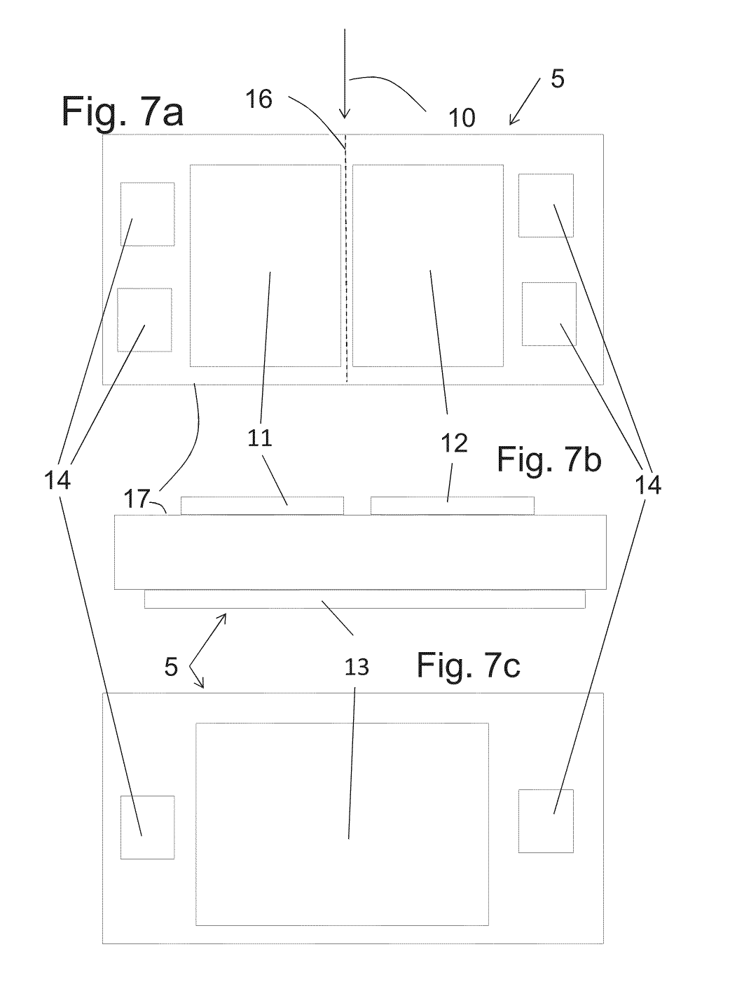

In the embodiments of FIGS. 7a-7c (7a top view, 7b side view and 7c bottom view) is shown a two sided humidity sensing element 5, where the heating element 13 is positioned at the back of the substrate 17 like in FIGS. 6a-6c and on the other side of the substrate 17 the humidity sensor 11 and temperature sensor 12 are located symmetrically on both sides of the center line 16 of the structure 5.

During the measurement while the radiosonde 1 is ascending in the atmosphere at least temperature and relative humidity of the atmosphere are measured by the radiosonde 1 and the humidity measurement is performed continuously in an elevated temperature and both the elevated temperature and ambient atmosphere temperature are measured simultaneously and based on these values relative humidity is determined.

Typically also the position of the radiosonde 1 is measured with e.g. a GPS-devices together and a pressure sensor.

Instead of heating of the humidity sensor 11 with constant power or by a set temperature difference the solution in accordance with the invention allows slow changes of the heating algorithm, in other words either the power may change during the measurmenet or the temperature difference during the measurement may vary. If this alternative is used, the change in the heating should be clearly slower (e.g. 1/10) than the temporal change in the humidity parameter to be measured.

The humidity sensing element 5 is typically planar and in some advantageous embodiments one-sided.

1. A method for a radiosonde where at least
temperature and relative humidity of the atmosphere are measured by a radiosonde,
wherein
the humidity measurement is performed continuously in an elevated temperature and both the elevated temperature and ambient air temperature are measured simultaneously and based on these values relative humidity is determined, and
the humidity sensing elements are positioned on a planar substrate.

2. The method according to claim 1, characterized in thatwherein the elevated temperature is formed as a constant temperature difference between the humidity sensor the ambient air.

3. The method according to claim 1, wherein the elevated temperature is formed by a constant heating power directed to the humidity sensor.

4. The method according to any previous claim 1, wherein an elevated temperature is formed in order to make the humidity measurement faster.

5. A radiosonde comprising at least
first temperature sensor for measuring the temperature of the atmosphere,
a humidity sensor,
a heating element positioned in thermal close connection with the humidity sensor, and
second temperature sensor for forming a humidity sensing element, wherein
the radiosonde includes means for controlling the power fed to the heating element such that the humidity sensor is during the complete measurement in an elevated temperature in relation to the temperature of the ambient air, and
the humidity sensing element is formed on a planar substrate.

6. The radiosonde according to claim 5, wherein the radiosonde includes means for controlling the heating power by maintaining a constant temperature difference between the humidity sensor the ambient air.

7. The radiosonde according to claim 5, wherein the radiosonde includes means for forming the elevated temperature by a constant heating power directed to the humidity sensor.

8. The radiosonde according to claim 5, wherein the radiosonde includes means for forming the elevated temperature by a slowly variable heating power directed to the humidity sensor.

9. The radiosonde according to claim 5, wherein the measurement elements relating to the measurement of the relative humidity are arranged symmetrically in relation to the air flow in order to make the temperature measurement of the humidity sensor as accurate as possible.

10. The radiosonde according to any previous apparatus claim 5, wherein the measurement elements are positioned symmetrically around vertical centreline of the humidity sensing element.
